(19) United States
(12) Patent Application Publication
(10) Pub. No.: US 2008/0028647 A1
(43) Pub. Date: Feb. 7, 2008

(54) SELF-ABSORBENT BEVERAGE HOLDER COASTER

(76) Inventor: Gary FRATIANNE, Avon Lake, OH (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/766,495

(22) Filed: Jun. 21, 2007

Related U.S. Application Data
(63) Continuation-in-part of application No. 11/562,612, filed on Nov. 22, 2006.
(60) Provisional application No. 60/739,036, filed on Nov. 22, 2005.

(51) Int. Cl. A47G 23/03; G09F 3/00

(52) U.S. Cl. 40/324; 220/738; 248/346.11

(57) ABSTRACT

A self-absorbent disposable coaster for different sized beverage holders is presented. The coaster is inserted into a beverage holder prior to placing a beverage container therein. Once the beverage has been consumed, or when the coaster has reached a predetermined saturation point, the coaster is discarded and a new coaster is inserted. Thus the beverage holder remains clean. The exterior surface of the coaster is, preferably, coated with an impermeable material, to prevent liquids absorbed by the coaster from passing through it to the beverage holder. The coaster further allows for the emplacement of an advertisement indicia on its surface. Data representative of advertising indicia to be provided on the self absorbent coasters is received via suitable communications network.

### CROSS-REFERENCE TO RELATED APPLICATIONS

This application is a continuation-in-part of U.S. patent application Ser. No. 11/562,612 filed Nov. 22, 2006, which claims priority to U.S. Provisional Patent Application Ser. No. 60/739,036 filed Nov. 22, 2005.

### BACKGROUND

The subject application is directed to coasters on which beverage containers and enclosures are placed so as to avoid damage of the surface underneath. In particular, the subject application is directed to a self-absorbing coaster adapted for use in a beverage holder of a vehicle, such as an automobile, boat, bus, and the like.

The typical automobile, boat, bus, light truck, tractor-trailer, or van typically comes equipped with at least one integrated beverage holder. Usually, this beverage holder is molded into the material of the dashboard, center console, door, or the like. Repeated use of the beverage holder to hold a beverage leaves a variety of residues in the holder, including spilt beverage, condensation, and the like. Over time, the buildup of such residue may lead to mold development, as well as being a gathering point for lint, paper, or other debris common to moving vehicles. Some previous attempts to alleviate this problem have included removable mats inserted into the bottom of the beverage holder. These mats are generally manufactured of a rubber-like material, which prevent moisture, beverage, and the like, from accumulating on the unprotected bottom of the holder. However, such a mat merely contains the spilt beverage, condensation, or the like, and must be removed for cleaning. In the event of a spill, the beverage remains on the mat until removal or evaporation leaves a sticky residue on the mat, requiring cleaning.

Additionally, aftermarket supplies of such mats may be limited, as each motor vehicle generally includes unique holders, as an industry standard size is not presently enforced. When such mats are available, they are typically expensive, as most aftermarket manufacturer accessories are. Further, cleaning such a mat or the beverage holder itself may be time consuming and is not convenient during a long trip.

### SUMMARY OF THE INVENTION

In accordance with the subject application, there is provided a self-absorbent coaster.

Further, in accordance with the subject application, there is provided a self-absorbing coaster adapted to fit a variety of beverage holder sizes.

Still further, in accordance with the subject application, there is provided a disposable coaster adapted to fit a variety of beverage holders located in a variety of vehicles.

In accordance with an embodiment of the subject application, there is provided a self absorbent coaster including a body. The body of the self absorbent coaster includes at least one layer of at least partially absorbent rigid material and an exterior surface. The body is characterized by an exterior diameter that substantially corresponds to an interior diameter of an associated beverage holder. The associated beverage holder is at least one of a plurality of different sized associated beverage holders, and includes an interior surface. The body of the self absorbent coaster is adapted for being removably inserted into an associated beverage holder such that a non-adhesive contact is enabled between at least a part of the bottom of the exterior surface of the body and a respective part of an interior surface of an associated beverage holder.

In one embodiment, the exterior surface of the body of the self absorbent coaster is coated at least partially with an impermeable material. The exterior surface of the body is, preferably, at least partially covered with note glue.

In one embodiment, the body has a disk shape and includes a top portion and a bottom portion. In this embodiment, the top portion of the exterior surface of the body of the self absorbent coaster is adapted for use as an advertising medium. In a preferred embodiment, the top portion of the exterior surface of the body depicts advertising indicia. Further, the top portion of the exterior surface of the body is, preferably, adapted for enabling a non-adhesive contact with at least a part of an exterior surface of an associated beverage enclosure. Preferably, the top portion of the exterior surface of the body is coated with a semi-impermeable material.

In another embodiment, the body of the self absorbent coaster is adapted for enveloping, at least partially, an associated beverage enclosure and includes an interior surface. In this embodiment, the body is capable of having a cup shape. The interior surface of the body is adapted for use as an advertising medium. In a preferred embodiment, the interior surface of the body of the self absorbent coaster depicts advertising indicia. Further, the interior surface of the body is, preferably, adapted for enabling a non-adhesive contact with at least a part of an exterior surface of an associated beverage enclosure. Preferably, the interior surface of the body of the self absorbent coaster is coated with a semi-impermeable material. In this embodiment, the interior surface of the body is, preferably, at least partially coated with note glue.

In another preferred embodiment, the at least one layer of the at least partially absorbent rigid material is selected from the group consisting of: at least partially card board, at least partially porous plastics, at least partially rubber, and at least partially cellulose. As will be appreciated by those skilled in the art, the body of the self absorbent coaster is, preferably, disposable. In another preferred embodiment, the body of the self absorbent coaster is provided with an aromatic scent. In yet another preferred embodiment, the body of the self absorbent coaster is provided with a deodorant.

Still other objects and aspects of the subject application will become readily apparent to those skilled in this art from the following description wherein there is shown and described a preferred embodiment of this invention, simply by way of illustration of one of the best modes suited for to carry out the invention. As it will be realized by those skilled in the art, the invention is capable of other different embodiments and its several details are capable of modifications in various obvious aspects all without departing from the scope of the present invention. Accordingly, the drawings and description will be regarded as illustrative in nature and not as restrictive.

### BRIEF DESCRIPTION OF DRAWINGS

The accompanying drawings incorporated in and forming a part of the specification, illustrate several aspects of the subject application, and together with the description serve to explain the principles of the subject application. In the drawings:

FIG. 1 illustrates a typical center console beverage holder of a vehicle in accordance with one embodiment of the subject application;

FIG. 2 illustrates a portion of a typical center console beverage holder of a vehicle in accordance with one embodiment of the subject application;

FIG. 3 illustrates using the body of the self absorbent coaster as an advertising medium in accordance with one embodiment of the subject application.

### DETAILED DESCRIPTION OF THE INVENTION

The subject application is directed to coasters on which beverage containers and enclosures are placed so as to avoid damage of the surface underneath. In particular, the subject application is directed to a self-absorbent coaster. More particularly, the subject application is directed to a self-absorbing coaster adapted for use in a beverage holder of a vehicle, such as an automobile, boat, bus, and the like.

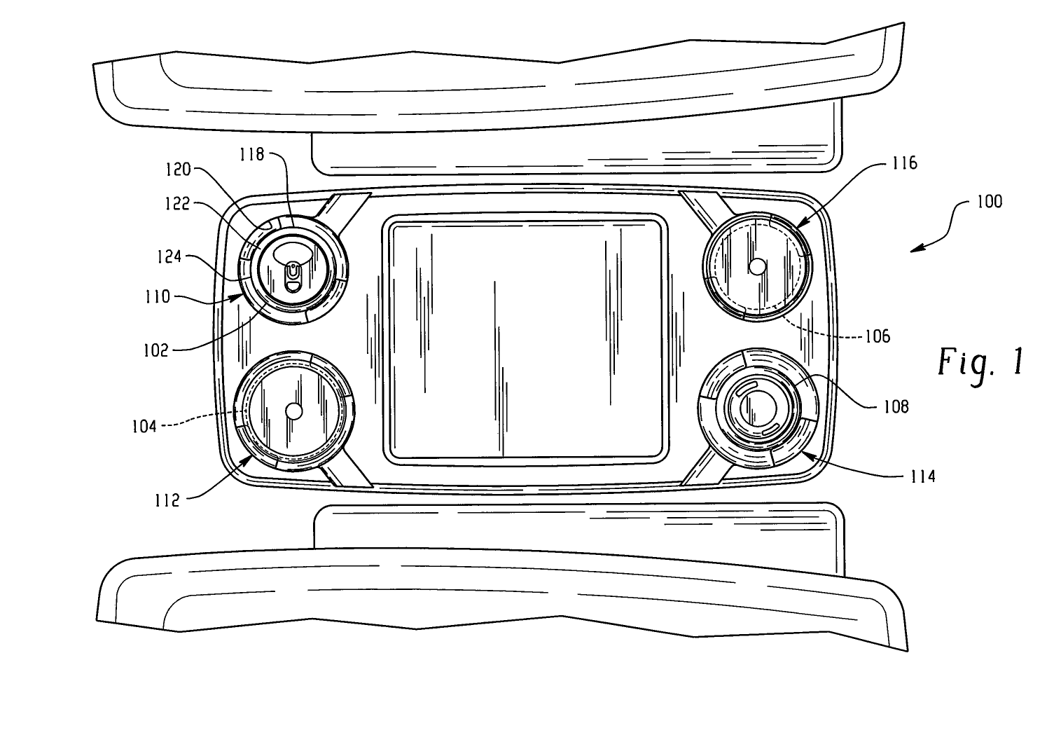

Turning now to FIG. 1, there is shown a typical center console beverage holder 100 of a vehicle. The console beverage holder 100 includes self absorbent coasters 102, 104, 106, and 108 inserted into different sized associated beverage holders 110, 112, 114, and 116, respectively. The self absorbent coasters 102, 104, 106, and 108 each include a body including at least one layer of at least partially absorbent rigid material. Further, the at least partially absorbent rigid material is adapted to absorb a plurality of liquid types of varying viscosity.

Those skilled in the art will recognize that the material of the at least one layer of the self absorbent coaster 102, 104, 106, and 108 is capable of being at least partially a card board material layer. The material of the at least one layer of the self absorbent coasters 102, 104, 106, and 108 is also capable of being at least partially a porous plastics, at least partially rubber, and at least partially cellulose material layer. It will be evident to a skilled artisan that other at least partially absorbent rigid materials known in the art are capable of being used for employing the self absorbent coasters 102, 104, 106, and 108 without departing from the scope of the subject application. Those skilled in the art will appreciate that the body of each of the self absorbent coasters 102, 104, 106, and 108, is characterized by an exterior diameter that generally complies with an interior diameter of an associated beverage holder 110, 112, 114, and 116, respectively.

As illustrated in FIG. 1, the exterior diameters of the self absorbent coasters 102, 104, 106, and 108 comply with the different sized associated beverage holders 110, 112, 114, and 116, respectively. It will be understood by those skilled in the art that beverage holders 110, 112, 114, and 116 are capable of having a variety of sizes and styles, including, for example and without limitation, holders capable of receiving large beverage containers on a raised outer ring on the bottom of the holder and small beverage containers on a recessed inner circle on the bottom of the holder. Further description will be made with respect to the self absorbent coaster 102. However, as will be apparent to a skilled artisan, self absorbent coasters 104, 106, and 108 are analogous to the self absorbent coaster 102. Hence, the description presented herein for the self absorbent coaster 102 equally applies to self absorbent coasters 104, 106, and 108.

Illustrated in FIG. 1 is one example embodiment of a self absorbent coaster in accordance with the subject application. As illustrated in FIG. 1, the body of the self absorbent coaster 102 has a cup shape and includes an exterior surface 118. The body of the self absorbent coaster 102 is adapted for being removably inserted into an associated beverage holder 110 such that a non-adhesive contact is enabled between at least a part of the exterior surface 118 of the body and a respective part of an interior surface 120 of an associated beverage holder 110. In a preferred embodiment, the exterior surface 118 is advantageously coated with an impermeable material, so as to prevent liquids absorbed by the self absorbent coaster 102 from passing through it to the associated beverage holder 110. The exterior surface 118 of the body is, preferably, at least partially covered with note glue. As will be appreciated by those skilled in the art, the latter provides an enhanced non-adhesive contact between at least a part of the exterior surface 118 of the body and a respective part of the interior surface 120 of an associated beverage holder 110.

The body is further adapted for enveloping at least partially an associated beverage enclosure 122. The body includes an interior surface 124 adapted for enabling a non-adhesive contact with at least a part of an exterior surface of an associated beverage enclosure 122. The interior surface 124 of the body of the self absorbent coaster 102 is, preferably, coated with a semi-impermeable material (not shown in the drawing). The latter advantageously allows liquid to be absorbed by the self absorbent coaster 102, but prevents the beverage enclosure 122 placed on the self absorbent coaster 102 from sticking to it. Those skilled in the art will further recognize that the interior surface 118 of the body is capable of being coated, at least partially, with note glue for providing an enhanced non-adhesive contact between at least a part of the interior surface 120 of the body and the beverage enclosure 122.

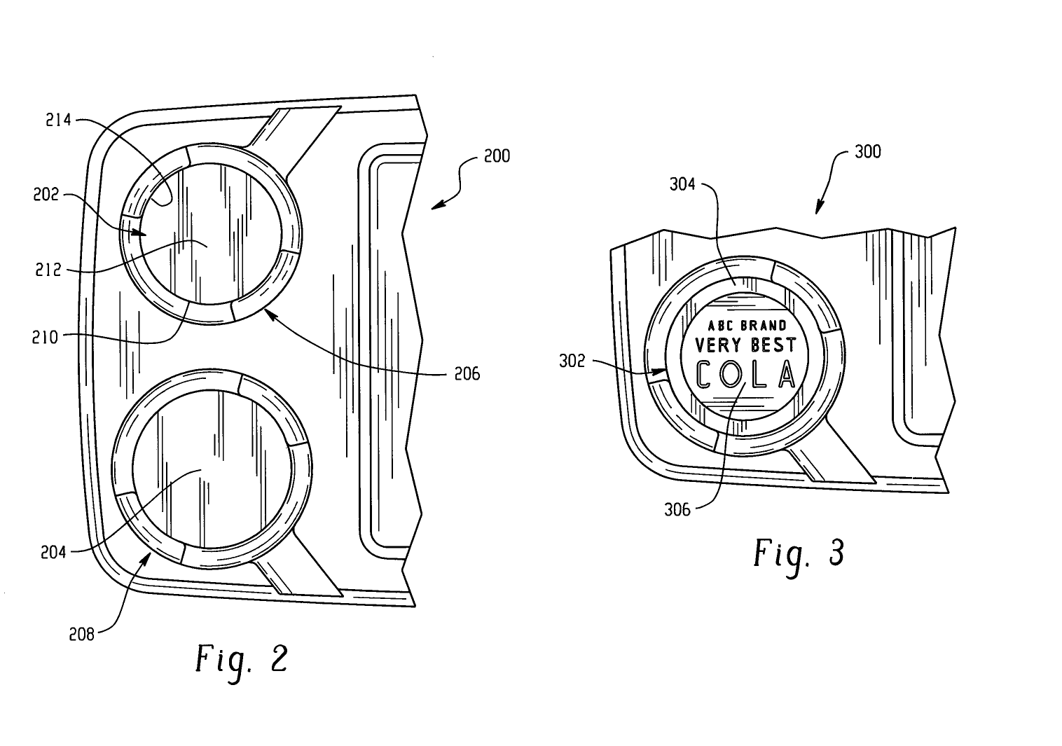

Turning now to FIG. 2, there is shown a portion of a typical center console beverage holder 200 including self absorbent coasters 202 and 204 in accordance with another embodiment of the subject application, inserted into different sized associated beverage holders 206 and 208, respectively. The self absorbent coasters 202 and 204 each include a body including at least one layer of at least partially absorbent rigid material. Further, the at least partially absorbent rigid material is adapted to absorb a plurality of liquid types of varying viscosity. Those skilled in the art will recognize that the material of the at least one layer of the self absorbent coaster 202 and 204 is capable of being at least partially a card board material layer. The material of the at least one layer of the self absorbent coasters 202 and 204 is also capable of being at least partially a porous plastics, at least partially rubber, and at least partially cellulose material layer. It will be evident to a skilled artisan that other at least partially absorbent rigid materials known in the art are capable of being used for employing the self absorbent coasters 202 and 204 without departing from the scope of the subject application. Those skilled in the art will appreciate that the body of each of the self absorbent coasters 202 and 204 is characterized by an exterior diameter that generally complies with an interior diameter of an associated beverage holder 206, 208, respectively.

As illustrated in FIG. 2, the exterior diameters of the self absorbent coasters 202 and 204 comply with the different sized associated beverage holders 206, 208, respectively. It will be understood by those skilled in the art that beverage holders 206, 208 are capable of having a variety of sizes and styles, including, for example and without limitation, holders capable of receiving large beverage containers on a raised outer ring on the bottom of the holder and small beverage containers on a recessed inner circle on the bottom of the holder. Further description will be made with respect to the self absorbent coaster 202. However, as will be apparent to a skilled artisan, the self absorbent coaster 204 is analogous to the self absorbent coaster 202. Hence, the description presented herein for the self absorbent coaster 202 equally applies to self absorbent coaster 204.

As illustrated in FIG. 2, the body of the self absorbent coaster 202 has a disk shape. The exterior surface 210 of the self absorbent coaster 202 includes a bottom portion (not shown in the drawing) and a top portion 212. The body is adapted for being removably inserted into an associated beverage holder 202 such that a non-adhesive contact is enabled between at least a part of the exterior surface 210 of the body and a respective part of an interior surface 214 of an associated beverage holder 202. In a preferred embodiment, the exterior surface 210 is advantageously coated with an impermeable material, so as to prevent liquids absorbed by the self absorbent coaster 202 from passing through it to the associated beverage holder 206. The exterior surface 210 of the body is, preferably, at least partially covered with note glue. As will be appreciated by those skilled in the art, the latter provides an enhanced non-adhesive contact between at least a part of the exterior surface 210 of the body and a respective part of the interior surface 214 of an associated beverage holder 202.

The top portion 212 of the exterior surface 210 of the body is adapted for enabling a non-adhesive contact with at least a part of an exterior surface of an associated beverage enclosure (not shown in the drawing). The top portion 212 of the exterior surface 210 of the body is, preferably, coated with a semi-impermeable material. The latter advantageously allows liquid to be absorbed by the self absorbent coaster 202, but prevents the beverage enclosure placed on the self absorbent coaster 202 from sticking to it. The top portion 212 of the exterior surface 210 of the body is, preferably, coated with a note glue, the latter providing an enhanced non-adhesive contact between the top portion 212 of the body and an associated beverage enclosure (not shown in FIG. 2).

As will be recognized by those skilled in the art, the self absorbent coasters 102 and 202 are, preferably, disposable. The bodies of self absorbent coasters 102, 202 are, preferably, provided with an aromatic scent. In another preferred embodiment, the bodies of self absorbent coasters 102, 202 are provided with a deodorant.

Turning now to FIG. 3, there is shown a portion of a typical center console beverage holder 300. In the example embodiment shown in FIG. 3, the self absorbent coaster 302 has a disk shape. The exterior surface of the body of the self absorbent coaster 302 includes a top portion 304 and a bottom portion (not shown in the drawing). The top portion 304 is used as an advertising medium. Those skilled in the art will appreciate that the top portion 304 of the exterior surface of the body of the self absorbent coaster 302 depicts logo information 306 of a particular company.

Operation of the self absorbent coaster of the subject application will be explained with reference to FIG. 1 and FIG. 3. Referring now to FIG. 1, self absorbent coasters 102, 104, 106, and 108 are inserted into different sized associated beverage holders 110, 112, 114, and 116, respectively. The self absorbent coasters 102, 104, 106, and 108 are inserted such that they rest on at least a portion of the bottom of a respective beverage holder 110, 112, 114, and 116.

Those skilled in the art will appreciate that the self absorbent coasters 102, 104, 106, and 108 after being inserted, advantageously engage themselves to the sides and bottom of a respective beverage holder 110, 112, 114, and 116 by means of the materials used in the construction of the respective self absorbent coasters 102, 104, 106, and 108. A user is then able to place a beverage container, such as a cup, bottle, can, or the like, (illustrated in FIG. 1 as a beverage enclosure 122) in the beverage holder 110 on top of the self absorbent coaster 102. As bumps, spills, condensation, and the like, occur the self absorbent coaster 102 suitably absorbs the liquids, preventing such liquid from coming into contact with the bottom and sides of the beverage holder 110.

Once the beverage has been consumed, or alternatively once the self absorbent coaster 102 has become saturated, the self absorbent coaster 102 is removed via any suitable means and replaced with a fresh self absorbent coaster. As will be recognized by those skilled in the art, the self absorbent coaster 102 is, preferably disposed after being removed from the respective beverage holder 110.

In a preferred embodiment of the subject application, as illustrated in FIG. 3, the self absorbent coaster 302 is adapted to receive advertisement indicia. Preferably, the advertisement indicia is a printed advertisement using ink absorbed directly onto the self absorbent coaster 302 via any means known in the art. Suitable examples of such techniques are shown on any printed paper or cotton napkins, towels, and the like. The skilled artisan will appreciate that other methods of affixing advertisement indicia on the self absorbent coaster 302 are capable of being advantageously used, without departing from the scope of the subject application. As will be appreciated by those skilled in the art, data representative of advertising indicia to be provided on the self absorbent coaster 302 is capable of being received, for example and without limitation, via suitable communications network.

The foregoing description of preferred embodiments of the subject application has been presented for purposes of illustration and description. It is not intended to be exhaustive or to limit the subject application to the precise form disclosed. Obvious modifications or variations are possible in light of the above teachings. The embodiments were chosen and described to provide the best illustration of the principles of the subject application and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A self absorbent coaster comprising:
a body including:
at least one layer of at least partially absorbent rigid material, and an exterior surface;
wherein the body is characterized by an exterior diameter that generally complies with an interior diameter of an associated beverage holder, which associated beverage holder is at least one of a plurality of different sized associated beverage holders, and which associated beverage holder includes an interior surface;
wherein the body is adapted for being removably inserted into an associated beverage holder such that a non-adhesive contact is enabled between at least a part of the exterior surface of the body and a respective part of an interior surface of an associated beverage holder.

2. The self absorbent coaster of claim 1 wherein the exterior surface of the body is coated at least partially with an impermeable material.

3. The self absorbent coaster of claim 1 wherein the body has a disk shape, and wherein the exterior surface of the body includes a top portion and a bottom portion.

4. The self absorbent coaster of claim 3 wherein the top portion of the exterior surface of the body is adapted for use as an advertising medium.

5. The self absorbent coaster of claim 4 wherein the top portion of the exterior surface of the body depicts advertising indicia.

6. The self absorbent coaster of claim 3 wherein the top portion of the exterior surface of the body is adapted for enabling a non-adhesive contact with at least a part of an exterior surface of an associated beverage enclosure.

7. The self absorbent coaster of claim 3 wherein the top portion of the exterior surface of the body is coated with a semi-impermeable material.

8. The self absorbent coaster of claim 1 wherein the body is further adapted for enveloping at least partially an associated beverage enclosure and includes an interior surface.

9. The self absorbent coaster of claim 8 wherein the body has a cup shape.

10. The self absorbent coaster of claim 8 wherein the interior surface of the body is adapted for use as an advertising medium.

11. The self absorbent coaster of claim 10 wherein the interior surface of the body depicts advertising indicia.

12. The self absorbent coaster of claim 8 wherein the interior surface of the body is adapted for enabling a non-adhesive contact with at least a part of an exterior surface of an associated beverage enclosure.

13. The self absorbent coaster of claim 8 wherein the interior surface of the body is coated with a semi-impermeable material.

14. The self absorbent coaster of claim 1 wherein at least one layer of the at least is partially absorbent rigid material is selected from the group consisting of: at least partially card board, at least partially porous plastics, at least partially rubber, and at least partially cellulose.

15. The self absorbent coaster of claim 1 wherein the body is disposable.

16. The self absorbent coaster of claim 1 wherein the body is provided with an aromatic scent.

17. The self absorbent coaster of claim 1 wherein the body is provided with a deodorant.

18. The self absorbent coaster of claim 1 wherein the exterior surface of the body is at least partially covered with note glue.

19. The self absorbent coaster of claim 8 wherein the interior surface of the body is at least partially coated with note glue.
